(19) United States
(12) Patent Application Publication
(10) Pub. No.: US 2026/0170429 A1
(43) Pub. Date: Jun. 18, 2026

(54) SYSTEMS AND PROCESSES FOR USING COMPUTER ALGORITHMS FOR PROVIDING ANALYTICS BY MODELING LABOR MARKETS

(71) Applicant: Lightcast, Moscow, ID (US)

(72) Inventors: David Beauchamp, Moscow, ID (US); Jeff Hoffman, Moscow, ID (US); Rohit Narasimhan, Moscow, ID (US); Seth Friman, Moscow, ID (US); Peng Zhao, Moscow, ID (US); John Pernsteiner, Moscow, ID (US); Tyson Silver, Moscow, ID (US)

(21) Appl. No.: 18/979,937

(22) Filed: Dec. 13, 2024

(51) Int. Cl. G06Q 10/0631; G06Q 30/0204

(52) U.S. Cl. CPC G06Q 10/06315; G06Q 30/0205

(57) ABSTRACT

Systems, methods, and devices for modeling labor markets and providing workforce estimates based on labor market data. Labor market data may be received from disparate data sources and the labor market data may be mapped to an occupation taxonomy and a confidence interval may be determined for the mapping. A workforce size for an occupational classification within a geographic region may be determined based on the mapping and the confidence interval. The workforce estimate may be transmitted based on the occupational classification and the geographic region.

### TECHNICAL FIELD

The present disclosure relates generally to the field of labor market analytics, specifically to systems and processes for modeling labor markets and providing workforce estimates.

### BACKGROUND

In the current global economy, businesses increasingly rely on labor market data to make critical decisions regarding workforce planning, hiring, and location selection. Such data allows companies to assess the availability of workers with specific skills across different geographic regions and make informed decisions based on local labor market conditions. However, obtaining accurate and actionable labor market insights is a significant challenge due to the disparity in how governments and regions report employment data. Labor market data provided by government agencies often lacks the granularity needed by businesses to differentiate between specialized occupations within broad occupational categories. For example, government data may report statistics for “software developers” in a region, but businesses often need more specific information, such as the number of Java or C++ developers available for hire.

Additionally, variations in the taxonomies used by different countries further complicate the process of comparing workforce data across regions. Different nations may classify labor market information using unique occupational categories, making it difficult for businesses to perform meaningful comparisons on a global scale. These discrepancies in occupational classifications hinder businesses from achieving a clear, standardized understanding of the available labor pool in different markets.

Beyond taxonomic challenges, the quality and reliability of labor market data can vary significantly between regions. Some countries provide robust and timely labor data, while others offer incomplete or outdated information. As a result, businesses may struggle to determine the true availability of workers in certain regions, especially in cases where labor data is scarce or unreliable.

Moreover, labor market data from public sources, such as government labor market information (LMI), typically does not account for emerging trends in remote work or new occupational categories created by technological advancements. These gaps in publicly available data further limit the ability of businesses to gain a complete and up-to-date picture of the labor market landscape.

In this context, there is a need for systems and processes that can standardize labor market data across regions, improve the granularity of workforce estimates, and provide businesses with reliable insights into both current and projected labor supply. Addressing these challenges would enable organizations to make better-informed decisions and remain competitive in the rapidly evolving global marketplace.

### SUMMARY

Briefly described, and in various aspects, the present disclosure generally relates to systems and processes for modeling labor markets and providing workforce estimates based on labor market data. Aspects of the disclosure may address the limitations of conventional labor market data reporting, which often lacks the granularity needed by businesses to make informed decisions regarding workforce availability and talent acquisition.

The disclosed systems and processes may receive labor market data from various sources, including government labor market information (LMI), job postings, and worker profiles. Labor market data may be used to determine a mapping between occupation taxonomies. For example, the occupation taxonomy may include the International Standard Classification of Occupations (ISCO-08) and/or a more detailed taxonomy specific to specialized occupations. The mapping process may standardize labor market data so that it may be compared across different regions and industries, providing businesses with detailed occupational breakdowns. To provide greater context, confidence intervals may be determined for the mapped labor market data. The confidence intervals may be based on factors such as sample size, geographic granularity, and/or volume of available data sources. Certain mappings may be replaced with proxy data from comparable regions if the labor market data in a particular region does not meet a minimum quality threshold.

Workforce sizes may be estimated for occupational classifications within specific geographic regions based on the determined mappings and confidence intervals. The workforce estimates may include a range of values, such as low, mid, and high estimates, e.g., with the range or width of the interval reflecting the level of confidence in the underlying data. The estimates may be transmitted to user interfaces or via application programming interfaces (APIs), enabling businesses to query, filter, and customize workforce data based on their specific needs. Moreover, workforce estimates may be aggregated across multiple occupational classifications and regions, providing businesses with comprehensive insights into the labor supply for various locations and occupations. Confidence intervals may be dynamically adjusted during the aggregation process to maintain reliability of the workforce estimates as the scope of the analysis expands.

By offering dynamic, granular workforce estimates with adjustable confidence intervals, the disclosed systems and processes may empower businesses to make data-driven decisions regarding workforce planning, hiring, and geographic expansion. The systems overcome challenges related to disparate labor market data reporting, taxonomic inconsistencies, and insufficient data quality, thereby enabling businesses to better navigate the complexities of the global labor market.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

Reference will now be made to the accompanying drawings, which are not necessarily drawn to scale.

FIG. 1 illustrates an example of an environment for a system for modeling labor markets and providing workforce estimates;

FIG. 2 illustrates an example process for mapping labor market data to an occupation taxonomy;

FIG. 3 illustrates an example process for calculating workforce estimates;

FIG. 4 illustrates an example of a process for modeling labor markets and providing workforce estimates based on labor market data;

FIG. 5 illustrates a schematic of an example of a computing device used in the modeling of labor markets and provision of workforce estimates; and

FIG. 6 illustrates an example diagrammatic representation of a machine in the form of a computer system.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

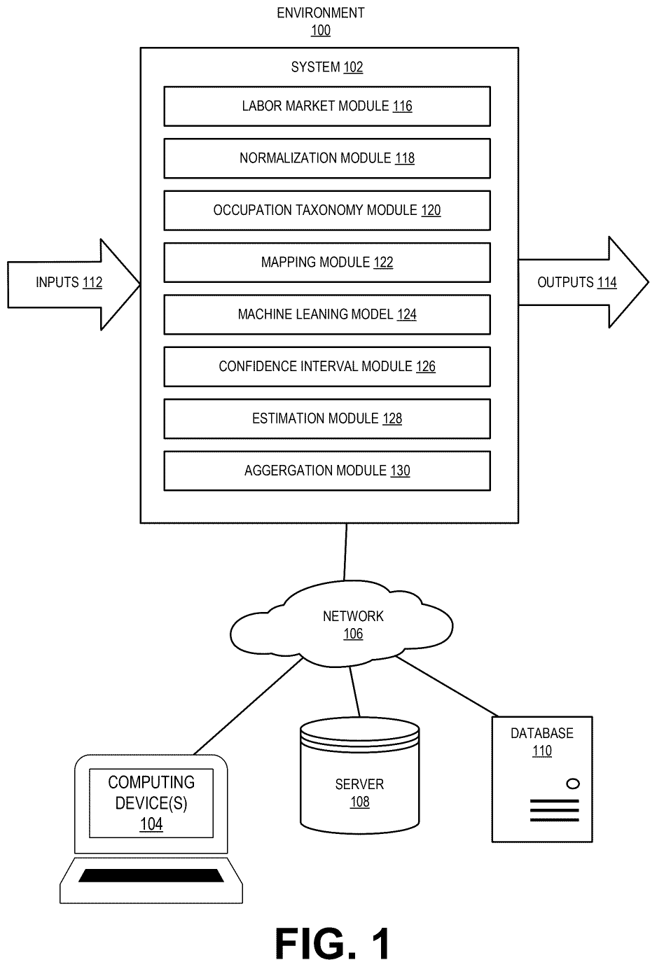

Referring now to the figures, for the purposes of example and explanation of the processes and components of the disclosed systems and methods, reference is made to FIG. 1, which illustrates an environment 100 for a system 102 for modeling labor markets and providing workforce estimates. The system 102 may address challenges associated with processing labor market data from disparate sources, such as government labor market information (LMI), job postings, and employment profiles, and transforming such data into detailed workforce estimates. The system 102 may overcome discrepancies in how labor data is reported across different regions, such as variations in occupational taxonomies and data granularity. These differences make it difficult for businesses to obtain accurate insights into the availability of specialized labor in specific regions.

The system 102 may receive one or more inputs 112, including labor market data, geographic information, user queries, socio-economic data, and/or occupation classifications (e.g., ISCO-08). The inputs 112 may provide foundational data that is processed through various modules to generate workforce estimates. System 102 may include multiple one or more modules, including a labor market module 116, a normalization module 118, an occupation taxonomy module 120, a mapping module 122, a machine learning module 124, a confidence interval module 126, an estimation module 128, and/or an aggregation module 130. The modules may work independently or in tandem to analyze and process the data and generate accurate and reliable workforce estimates.

The labor market module 116 may collect, manage, and/or preprocess labor market data from a wide variety of public and private sources. The labor market data may include data from structured sources (e.g., government labor statistics) and/or unstructured sources (e.g., job postings or worker profiles collected from professional networks). According to some aspects, the labor market data may include an occupation taxonomy that organizes jobs into hierarchical classifications, such as ISCO-08, or more specialized taxonomies tailored to industry-specific roles. The labor market data may also include a sample of labor market information for each occupation in a geographic region, providing granular insights into workforce distribution. For example, labor market data may detail the number of workers employed in various occupations, the skills associated with specific roles, salary ranges, employment trends, and/or geographic identifiers. Moreover, the labor market data may capture emerging trends, such as remote work prevalence or demand for new technology-driven occupations, ensuring relevance and adaptability to rapidly evolving market conditions. These diverse data components, when integrated, may enable comprehensive analysis and provide a robust foundation for modeling labor markets and generating workforce estimates.

The labor market module 116 may gather data in a timely manner and structure it appropriately for further processing. According to some aspects, the data market module 116 may use automated data scraping techniques and/or API integrations to gather data that encompasses a broad spectrum of occupational classifications and geographic regions. To enhance the granularity of workforce estimates, the labor market module 116 may integrate data from job postings and worker profiles. These unstructured data sources may provide valuable insights into specific skill sets and qualifications that are often absent from government-reported data. For example, while government statistics may report a general category such as “software developers,” the job postings data collected by the labor market module 116 may be used by the system 102 to further refine this category by identifying the specific skills in demand, such as expertise in Java or Python programming. This integration of multiple data sources may be used by the system 102 to provide detailed and accurate workforce estimates, giving businesses a better understanding of the available talent pool.

According to some aspects, the labor market module 116 may facilitate the proportional mapping of labor market data to specialized occupational classifications. For example, the labor market module may derive ratios between the ISCO-08 occupations and specialized occupations defined within a taxonomy. For example, the system 102 may use job postings data to determine that within a given region, 60% of software developers are Java developers, while 40% are Python developers.

The normalization module 118 may process and standardize the incoming labor market data by transforming it into a uniform format. Moreover, since labor market data from different regions can use different taxonomies and categorization schemes, the normalization module 118 may normalize the labor market data to a consistent structure. This consistent structure may enable cross-region comparisons and standardizing occupation classifications. For example, the normalization module 118 may ensure that occupational data can be reliably mapped across various regions, facilitating consistent analysis and comparisons.

Moreover, the normalization module 118 may address the problem of disparate labor data reporting standards, which may vary significantly across countries. For example, labor market data from the U.S. may report different occupational classifications compared to other countries such as India or China, making it challenging to make accurate workforce estimations. The normalization module 118 may address this issue by normalizing the incoming data into a common format, such as the International Standard Classification of Occupations (ISCO-08).

According to some aspects, the normalization module 118 may validate the labor market data. For example, the normalization module 118 may identify and/or flag inconsistencies or gaps in the labor market data, which could potentially affect the accuracy of workforce estimates. For example, if labor market data for a specific region or occupation lacks sufficient granularity, the normalization module 118 may flag the data and trigger the use of proxy data from comparable regions with similar economic conditions. This data substitution may fill in gaps where the available data is insufficient, leveraging comparable regions that share economic and occupational characteristics. Moreover, the system 102 may use machine learning models (e.g., machine learning module 124) to analyze data quality and determine the reliability of the labor market information. Analysis of the data quality and/or determination of the reliability of the labor market information may help businesses make informed decisions based on reliable and high-quality labor market insights, mitigating the risk of basing decisions on incomplete or inaccurate data.

The occupation taxonomy module 120 of the system 102 may manage and/or organize occupational data, addressing the challenges of standardizing diverse labor classifications across different regions and sources. For example, the occupation taxonomy module 120 may classify the occupation data base on the International Standard Classification of Occupations (ISCO-08) and/or the classification may be extended to incorporate specialized occupation mappings tailored to specific roles, such as “Java developers” or “cloud engineers.” By establishing a robust taxonomy, the occupation taxonomy module 120 may ensure that labor market data from various sources can be compared consistently across geographies, which may allow the system 102 to generate accurate workforce estimates at a more granular level than traditional government-reported data.

According to some aspects, the occupation taxonomy module 120 may align diverse labor market data into a unified structure, allowing for precise analysis and reporting. For instance, while ISCO-08 might classify all software developers under a single broad category, businesses often require more specific insights, such as the proportion of developers specializing in Python versus Java. The occupation taxonomy module 120 may provide such granularity by organizing labor data into a custom taxonomy, e.g., providing more specialized categories than the broad categories of ISCO-08. This higher level of detail may enable users to analyze labor markets with more precision, addressing the limitations of general classifications that lack specificity.

Moreover, the occupation taxonomy module 120 may address discrepancies that arise when governments report labor market data using varying taxonomies, as seen between countries such as China, India, and the U.S. By cross-referencing government data with a custom taxonomy, the occupation taxonomy module 120 may break down occupational data into specialized categories. The occupation taxonomy module 120 may create links or tags between ISCO-08 and custom classifications, using data such as job postings and worker profiles to provide accurate mappings. For example, a job posting for a “Python developer” may be tagged under both ISCO and custom taxonomies, allowing the system 102 to precisely map occupational categories.

According to some aspects, the occupation taxonomy module 120 may adapt to evolving labor market needs while maintaining a stable taxonomy for comparative analysis over time. Changes to taxonomies may be introduced gradually as new occupations emerge to avoid disrupting longitudinal analyses. For example, as the demand for new technology roles such as machine learning engineers grows, the occupation taxonomy module 120 may incorporate the new roles into the taxonomy while retaining the ability to compare labor data with older classifications. This balance between adaptability and stability may allow businesses to track trends and make informed decisions about future workforce planning.

The mapping module 122 may create mappings (e.g., proportional mappings) between the normalized labor market data and the occupation taxonomy, such as the International Standard Classification of Occupations (ISCO-08) or custom taxonomies specific to specialized job roles. The mapping module 122 may ensure that labor market data from various sources can be accurately categorized and analyzed, addressing the discrepancies in reporting standards between different countries and regions. A key technical solution offered by the mapping module 122 is its ability to handle diverse occupational classifications and transform them into a unified structure for consistent analysis.

According to some aspects, the mapping module 122 may generate proportional mappings by analyzing the frequency of job postings or worker profiles in each region. For example, the mapping module 122 may use job postings to determine that 60% of software developers in a specific region specialize in Java, while 40% specialize in Python. The mappings may be based on the data available in job postings, profiles, and labor market information (LMI). The mapping module 122 may assign proportional values (e.g., ratios) between occupations in the taxonomy and specialized roles. For example, if government data lists 1,000 software developers in a city, the module can break that figure down into specialized roles, such as 600 Java developers and 400 Python developers.

Moreover, the mapping module 122 may ensure the mappings are statistically robust. The mapping module may use confidence intervals (e.g., determined by the confidence interval module 126) associated with the ratios to account for data quality and sample size, especially when data in a region is sparse. For example, if the sample size for a specific occupation is small or unreliable, the mapping module 122 may adjust the mappings by introducing proxy data from comparable regions. The use of proxy regions may enable the system 102 to maintain accuracy even in areas where direct data is insufficient. By leveraging similar markets, the mapping module 122 may provide more reliable estimates.

Additionally, the mapping module 122 may support dynamic updates to the mappings as new data becomes available. The mapping module 122 may continuously refine the mappings by incorporating new job postings or employment profiles. This adaptability may allow the system 102 to adjust to evolving labor market trends and maintain the accuracy of workforce estimates over time. For example, as demand for new roles such as machine learning engineers increases, the mapping module 122 may update the mappings to reflect these emerging occupations, thereby providing up-to-date insights into labor market availability.

The ability of the system 102 to aggregate workforce estimates across multiple regions and occupations may also be supported by the mapping module 122. The mapping module 122 may calculate low, mid, and high estimates for each occupation, keeping the aggregated data reliable. The aggregation may use mathematical techniques (e.g., Pythagorean/Euclidean distance summation) to refine confidence intervals and improve the precision of estimates as the scope of the analysis expands. For example, when aggregating workforce data across regions such as New York, Los Angeles, and Atlanta, the mapping module 122 may ensure that the combined estimates for occupations such as “Java developers” remain statistically sound, thereby enhancing decision-making capabilities for businesses looking to hire specialized talent.

The machine learning module 124 may refine workforce estimates and mappings by applying advanced analytics to enhance accuracy and adapt to real-time labor market changes. The machine learning module 124 may use one or more trained machine learning models, continuously learning from historical data, user feedback, and/or evolving market trends. By analyzing data patterns, the machine learning module 124 may dynamically adjust the mappings between normalized labor market data and the occupation taxonomy, improving the reliability of the estimates for specialized job roles, such as Java developers or cloud engineers. For example, as demand increases for machine learning engineers, the machine learning module 124 may adapt and fine-tune its predictions to reflect these emerging roles.

According to some aspects, in collaboration with other modules of the system 102, the machine learning module 124 may ensure data quality and robustness. For example, the labor market module 116 may collect and preprocess labor market data from various sources, including job postings and worker profiles. The labor market data may be passed to the machine learning module 124, which may use the labor market data to refine its machine learning model(s) and/or predict the distribution of specific roles within broader categories. For example, in a given region, the machine learning module 124 may predict that a higher percentage of software developers are Java developers rather than Python developers based on data trends and regional characteristics. The normalization module 118 may ensure that the data is standardized, allowing the machine learning module 124 to compare and analyze data across different regions effectively.

The occupation taxonomy module 120 may use the machine learning module 124 to enhance its ability to manage and organize occupational data. The machine learning module 124 may continuously analyze labor market data, identifying emerging job roles and adjusting the taxonomy to reflect real-time labor market trends. This dynamic capability of the machine learning module 124 may facilitate automatic update of classifications, e.g., so that new specializations are accurately represented. Regional differences in occupational classifications may be refined as the machine learning module 124 aligns region-specific variations and harmonizes classifications across diverse data sets. Moreover, the machine learning module 124 may integrate user feedback to refine occupational categories based on specific queries and provide consistency in how occupations are classified across different data sources.

The mapping module 122 may use the machine learning module 124 to create mappings between normalized labor market data and the occupation taxonomy. The mapping module 122 may leverage advanced analytics of the machine learning module 124 to create accurate and proportional mappings between normalized labor market data and the occupation taxonomy. The machine learning module 124 may continuously analyze data from multiple sources, such as job postings and employment profiles, to detect patterns and trends in occupational distributions across regions. The mapping module 122 may dynamically adjust and refine the mappings in real time, ensuring that specialized roles are accurately represented within broader occupational categories. Additionally, the machine learning module 124 may enhance the precision of the mappings by factoring in historical data, market fluctuations, and/or user interactions, allowing the mapping module 122 to create more reliable mappings even when data for specific regions or roles is sparse.

The confidence interval module 126 of system 102 may determine statistical confidence levels for workforce estimates and/or occupational data to understand a degree of uncertainty in the data. The confidence interval module 126 may provide low, mid, and high workforce size estimates, calculated based on factors such as the sample size, data quality, and the specificity of geographic regions. For example, if a sample size for a specific occupation in a region is small, the confidence interval may be wider, reflecting higher uncertainty. Conversely, for regions with large, high-quality datasets, the confidence interval may be narrower, indicating more confidence in the workforce estimates.

The confidence interval module 126 may determine the confidence interval based on a sample of labor market data, which may include granular information for each occupation within a specified geographic region. The labor market data sample may encompass a variety of metrics, such as the number of job postings, employment records, and/or occupational classifications aligned with a predefined taxonomy, such as ISCO-08. The confidence interval module 126 may evaluate the sample size, data variability, and/or data quality to determine confidence intervals that accurately reflect the degree of certainty in the underlying data. For example, in regions where the sample size of job postings or employment data for “Data Scientists” is large and consistent across sources, the confidence interval may be narrower, indicating higher reliability. Conversely, in regions with sparse data or significant variability in reported figures, the confidence interval may be wider to account for potential inaccuracies. By leveraging these statistical evaluations, the confidence interval module 122 may ensure that workforce estimates are accompanied by an appropriate measure of reliability, enabling informed decision-making for labor market analyses.

According to some aspects, the confidence interval module 126 may determine confidence intervals by applying statistical techniques, such as bootstrapping and/or Bayesian inference, to evaluate accuracy of workforce estimates based on sample size, data quality, and geographic specificity. For example, bootstrapping may be used by the confidence interval module 126 to resample available labor market data, generating multiple simulated datasets to calculate variance and standard deviation, further informing confidence levels for workforce estimates. Bayesian inference may be used to incorporate prior knowledge, such as historical data or typical occupational distributions, when calculating confidence intervals. Bayesian inference may be particularly helpful in cases with small sample sizes or low data reliability. For example, if estimating workforce size for “cloud engineers” in a small market, the confidence interval module 126 may use a Bayesian prior based on broader regional data to adjust the confidence interval. Moreover, when aggregating data from multiple regions, the module may use weighted averaging and Pythagorean/Euclidean distance summation to reduce the impact of variance across regions, yielding tighter confidence intervals where data consistency is high.

The confidence interval module 126 may dynamically adjust the confidence intervals when data from multiple regions are aggregated, such as when proxy data is used. If a region lacks sufficient data for an accurate estimate, comparable regions with similar economic and occupational profiles may be used as proxies. The confidence interval module 126 may expand the confidence interval in such cases to account for the reduced data reliability, providing a more realistic range. For example, workforce estimates for “software developers” in a region with poor data quality may be bolstered by data from similar regions, but with a wider confidence interval to reflect the proxy usage.

To enhance the accuracy of workforce estimates, the confidence interval module 126 may apply different levels of expansion based on the degree of similarity between regions. For example, if the data for a region is supplemented by data from regions within the same country, the expansion of the confidence interval may be minor. However, if the data is supplemented by data from regions in another country, the expansion may be more significant, reflecting the potential differences in labor markets across national borders.

Moreover, the confidence interval module 126 may determine confidence intervals using a tiered approach that accounts for the employment size of specific occupations in a region. Larger employment samples may result in more conservative expansions of confidence intervals to avoid distorting workforce estimates. The determined confidence interval may allow the system 102 to maintain precision when estimating workforce sizes, such as for larger labor pools where misestimations may have a more significant impact.

In addition to handling individual estimates, the confidence interval module 126 may support aggregation across multiple occupations and regions. When workforce estimates are combined, such as for a set of specialized occupations across multiple cities, the confidence interval module 126 may apply one or more mathematical techniques, such as the Pythagorean sum, to maintain statistical rigor. This aggregation may reduce expansion of confidence intervals, increasing the reliability of aggregated workforce estimates as the system 102 accumulates more data points from various regions and occupations.

The estimation module 128 of the system 102 may determine one or more workforce size estimates for specific occupations within designated geographic regions, utilizing one or more of the mappings and/or confidence intervals produced by other modules of the system 102. The estimation module 128 may integrate data from sources such as job postings, government labor market information (LMI), and/or worker profiles, including adjusting for various data dimensions to enhance estimate reliability. For each occupation, the estimation module 128 may proportionally distribute workforce size across specialized occupational categories within the broader International Standard Classification of Occupations (ISCO-08) taxonomy based on the calculated ratios from the mapping module 122.

According to some aspects, the estimation module 128 may determine the most likely workforce size for each occupation by analyzing proportional data points and factoring in the confidence intervals generated by the confidence interval module 126. Moreover low, mid, and high estimates may be determined for each occupation. The estimates may provide businesses with a range of possible workforce sizes based on data variability. The estimation approach may minimize errors by weighting workforce estimates according to the quality and specificity of the input data. For example, if a ratio of Java developers to the overall software development workforce in a region is derived from a robust data sample, the estimation module 128 may confidently assign a workforce estimate range with a narrow confidence interval, supporting better accuracy.

When generating estimates for regions with limited or variable data, the estimation module 128 may rely on proxy data from comparable markets, determined by shared economic or demographic traits. Moreover, the system 102 may broaden the confidence intervals for estimates for regions with limited or variable data to account for uncertainties associated with proxy data. For example, if labor market data for a specialized occupation in a small metro area lacks adequate postings, the estimation module may utilize ratios derived from economically and demographically similar regions. This flexibility may enable the estimation module 128 to produce more informed workforce estimates, even in data-scarce areas, while signaling reduced confidence through expanded intervals.

According to some aspects, the estimation module 128 may aggregate workforce estimates across multiple regions or occupations, facilitating analyses that span broader labor pools or specialized roles. When combining workforce data for occupations across diverse regions, the estimation module 128 may apply one or more mathematical techniques, such as Pythagorean summation, to calculate low and high estimates. For example, use of Pythagorean summation may constrain variance growth and enhance confidence as estimates are aggregated. The aggregated estimates may provide businesses with stable, statistically sound workforce insights, even when combining data from regions with variable data quality.

In some aspects, the estimation module 128 may continuously integrate new data and adjust estimates based on emerging trends or shifts in labor demand, providing businesses with up-to-date insights. For example, as the demand for AI and machine learning specialists increases, the estimation module 128 may recalibrate estimates in real-time to reflect these emerging roles accurately. Through these dynamic updates, the estimation module 128 may ensure that workforce size estimates remain relevant and aligned with current labor market conditions, empowering businesses to make data-driven decisions regarding workforce planning and geographic expansion.

The aggregation module 130 of the system 102 may synthesize workforce estimates across different geographic regions and occupational classifications. By integrating estimates from multiple sources, the aggregation module 130 may allow businesses to perform more comprehensive workforce analyses that extend beyond isolated regions or individual occupations. This aggregation module 130 may standardize data from various countries and metropolitan areas, enabling direct comparisons of workforce sizes at a highly granular level.

Based on one or more user or system inputs, the aggregation module 130 may determine one or more customizable groupings of occupations and regions, allowing businesses to define specific categories that meet their unique needs. For example, the aggregation module 130 may aggregate workforce estimates for “Warehouse Workers” and “Warehouse Supervisors” across multiple cities, such as Boston and New York City. The aggregation module 130 may sum the mid estimates for each occupation in each city, while calculating the low and high estimates using the Pythagorean sum to preserve statistical accuracy. The customized grouping may allow businesses to understand workforce availability across custom-defined regions or combined job categories.

By employing the one or more modules, the system 102 may handle varying data quality and maintain robust confidence intervals to deliver reliable, large-scale workforce insights. Based on the outputs 114 of the system 102, organizations may make data-driven decisions regarding hiring strategies and location planning, leveraging labor market data that accounts for complex geographic and occupational factors. The flexibility of the system 102 in handling multiple layers of data granularity, from local metro areas to national labor pools, may further enhance its utility, providing critical, scalable labor market analytics for a range of business applications.

The system 102 may generate outputs 114 that deliver precise and actionable workforce estimates for a variety of occupations within designated geographic regions, enabling businesses to obtain highly tailored labor market insights. The outputs 114 may include data on workforce sizes segmented by occupation, geographic specificity, and/or associated confidence intervals (e.g., reflecting the data reliability). The workforce estimates may be determined from a combination of public and private labor data sources, normalized and mapped to a unified occupation taxonomy, ensuring compatibility across regions and industries. By incorporating confidence intervals, the system 102 may provide a range of potential workforce sizes (e.g., low, mid, and high estimates) to account for data variability, helping businesses understand the degree of certainty with which they can interpret the workforce estimates. For example, the system 102 may deliver data indicating a high demand but limited supply of data scientists in a region, providing a workforce size estimate along with a confidence interval that reflects the data quality and sample size in that region.

The outputs 114, including the workforce estimates along with their associated confidence intervals, may be made accessible through multiple technical avenues, such as an application programming interface (API) and user interfaces tailored for analysis. The API may allow seamless integration of the workforce data into external business intelligence systems, enabling organizations to automatically incorporate labor insights into decision-making workflows, such as HR software or geographic expansion tools. For example, a company may retrieve estimates for “Java developers” in a specific city via an API call and directly feed this data into its workforce planning tool, enabling real-time analysis and scenario planning. Alternatively, user interfaces may provide graphical representations of workforce distributions, segmented confidence intervals, and trend analysis, enhancing usability for professionals analyzing market conditions. This flexibility in data access and presentation may allow businesses to customize workforce data usage according to their unique strategic needs, whether for detailed internal reports or integrated analytics across platforms.

According to some aspects, one or more modules of the system 102 may be performed by the one or more computing devices 104. The one or more computing devices 104 may process and analyze extensive labor market data to deliver granular workforce estimates for various specialized occupations and regions. The one or more computing devices 104 may process large datasets, including job postings, government labor market information (LMI), and worker profiles, and transform them into occupation-specific insights. By applying a custom occupation taxonomy (e.g., providing a more detailed classification than ISCO-08), the system 102 may provide, via the one or more computing devices 104, proportional mappings and detailed ratio calculations across distinct occupations. Moreover, broad occupational categories may be broken down into highly specific roles, such as differentiating between Java developers and Python developers within the broader software development category. By dynamically adjusting workforce estimates according to regional data quality and incorporating comparable data where necessary, the computing devices 104 may ensure the accuracy and relevance of the insights they generate.

According to some aspects, the computing devices 104 may provide data communication pathways within the environment 100, transmitting data, mappings, confidence intervals, and/or workforce estimates between modules of the system 102 and/or external systems. The one or more computing devices 104 may include processors and memory capable of scaling to high-throughput workloads, allowing the system 102 to adjust workforce estimates in real time based on continuously updated labor market trends. Additionally, the one or more computing devices 104 may enable interaction with user interfaces and APIs, ensuring that workforce data, such as workforce size estimates and confidence intervals, are readily available for integration into client systems. By supporting multi-core and GPU acceleration, the devices 104 may enhance the scalability of the system 102, accommodating high-demand queries that businesses may rely on for real-time workforce planning and hiring analytics.

The server 108 may function as a central processing unit, managing the execution of key analytical processes and coordinating the operations of various modules of the system 102, such as the mapping, estimation, and confidence interval modules. The server 108 may receive labor market data inputs 112 and process the inputs 112 through the different stages of workforce estimation, overseeing the application of an occupation taxonomy and ensuring that mappings are accurately assigned to reflect regional or skill-specific needs. As data is ingested, the server 108 may coordinate between modules of the system 102 to produce the final workforce estimates while ensuring that any feedback or adjustments are appropriately managed. For example, the server 108 may recalibrate mappings or confidence intervals based on updated labor trends or client-specific requirements, adapting to evolving labor market conditions to maintain accurate, real-time insights.

According to some aspects, the server 108 may optimize processing efficiency through advanced techniques such as batch processing, GPU acceleration, and/or data caching. By applying these techniques, the server 108 may support high-speed data retrieval and processing, allowing the system 102 to generate reliable and timely workforce estimates. As a central hub, the server 108 may manage requests from external systems, seamlessly integrating with APIs to facilitate data sharing and enabling external clients to access workforce estimates within their own labor market analytics platforms. Through its coordinated control over system resources and data flows, the server 108 may ensure that the system 102 operates reliably and efficiently, even under high workloads, providing businesses with dependable labor market analytics.

The database 110 may provide storage for the system 102, such as housing extensive datasets required for generating workforce estimates. The database 110 may store both raw and processed labor market data from multiple sources (e.g., including government-provided LMI, job postings, and/or worker profiles), enabling the system to analyze labor market conditions at various levels of granularity. In addition to raw labor market data, the database 110 may store confidence intervals and historical data patterns for adjusting workforce estimates and ensuring data reliability. For example, when regional data is sparse, the system 102 may retrieve proxy data from comparable regions stored in the database 110 to supplement estimates. Moreover, the database 110 may store configurations for different estimation parameters and/or user-defined criteria, allowing the system 102 to deliver customized workforce analytics based on specific needs, such as aggregating estimates across custom occupational categories or geographic regions. The database 110 may provide consistent data quality across varying regions and occupations, allowing system 102 to offer reliable, scalable labor market insights to businesses.

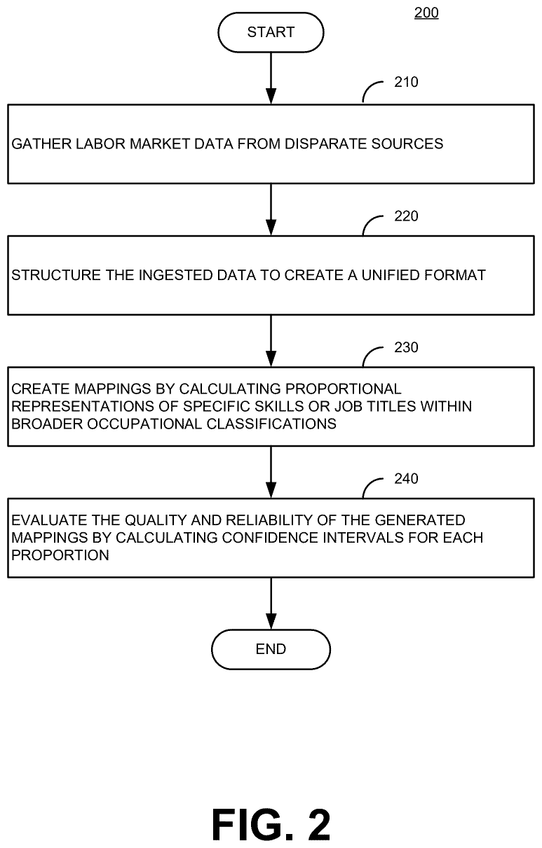

FIG. 2 illustrates an example of a process 200 for mapping labor market data to an occupation taxonomy. Process 200 may be used by the system 102 to provide data consistency, relevance, and/or accuracy across multiple sources.

At step 210, the process 200 may gather labor market data from disparate sources, including government labor market information (LMI), job postings, and/or employment profiles. The process 200 may capture high-granularity data points (e.g., job titles, skill requirements, and/or location specifications) via an automated data pipeline, including API integrations and/or web-scraping techniques. According to some aspects, process 200 may employ error-handling commands to detect and log incomplete or inconsistent entries, flagging them for review or correction to maintain data integrity. Moreover, the error handling commands may automatically replace missing or unstructured data fields with placeholders or default values so that downstream processes may continue without interruption or degradation in data quality. Furthermore, the process 200 may log any incomplete or inconsistent entries for review. By using concurrent data retrieval methods, the process 200 may efficiently handle large data volumes from multiple sources and provide near-real-time updates. The collected data may be stored in a central database structured to support high-throughput queries, allowing for swift access and seamless transitions to subsequent processing steps.

According to some aspects, the process 200 may pre-process the data to ensure data consistency upon ingestion. For example, job postings may be parsed into standardized fields for categorization. Relevant skills and job titles may be identified with natural language processing (NLP) models. Keywords and phrase matching techniques may be used to similarly categorize equivalent job titles (e.g., “Java Developer” and “Java Software Engineer”), preventing misclassification. This initial processing addresses challenges arising from regional or linguistic variations in job descriptions, establishing a foundational dataset from which meaningful labor insights can be derived.

At step 220, the process 200 may structure the ingested data to create a unified format aligning with a predefined occupational taxonomy, such as the International Standard Classification of Occupations (ISCO-08). The process 200 may apply a normalization function that standardizes job titles, skills, and/or region identifiers into consistent formats, allowing for accurate cross-regional and cross-source comparisons. NLP-based transformation scripts may be used to identify and align synonymous job titles across different data sources, reducing discrepancies that may arise from variations in reporting conventions. For example, an entry listed as “Java developer” in one region may be aligned with the broader category of “software developer,” facilitating streamlined analysis. According to some aspects, the normalization may help to maintain structured, organized data suitable for precise analysis.

To address language-specific variations and standardization challenges effectively, the process 200 may utilize advanced tokenization and translation techniques to interpret non-English job descriptions accurately and align them with the defined occupational taxonomy. Tokenization may segment each job description into meaningful units, such as keywords, industry terms, and skill indicators, which may be used to capture nuances across languages and dialects. The tokens may be processed through a language model trained on both general and labor market-specific vocabulary, ensuring accurate translations that maintain the intent and specificity of the original descriptions. For example, if a job posting describes a role as “desarrollador de software”, the process tokenizes key terms like “desarrollador” and “software,” facilitating a reliable match to the corresponding English-language taxonomy entry (e.g., “software developer”). This approach may help maintain consistency across languages, enabling users to query a single term like “software developer” and receive results regardless of the job posting's original language.

To handle potential discrepancies and variations, the process 200 may incorporate a validation mechanism, checking translated terms against an industry-standardized list to confirm alignment with the occupation taxonomy. Translated job descriptions may be cross-referenced with a predefined list of recognized job titles and skills to identify and correct potential ambiguities or mismatches. For example, if a role is translated as “data scientist” but includes tokens for “machine learning” and “statistics” that may suggest alternative classifications (e.g., “machine learning engineer”), the process 200 may flag the translation for review, prompting automated verification based on pre-defined accuracy thresholds. Additionally, geographic data fields, such as country or city names, may be extracted from the labor market data and mapped to a standardized format, further ensuring that jobs are correctly filtered by location. By standardizing both job descriptions and location identifiers, the consistency of data across regions and languages may be increased, providing businesses with high-confidence insights into global labor market trends and workforce availability.

At step 230, the process 200 may create mappings by calculating proportional representations of specific skills or job titles within broader occupational classifications. Data points may be aggregated within each occupation and ratios may be calculated based on the frequency of certain skills or job titles observed in the dataset. For example, if the process 200 identifies 1,000 software developer positions in a given area, with 600 listings specifying Java expertise, it may determine that 60% of the software developers in that region specialize in Java. This proportional mapping approach may leverage weighted averaging, giving more influence to data points from sources deemed more reliable or recent. Additionally, occupation-specific ratios may be computed using statistical commands that adjust for skew, ensuring that the mappings accurately reflect real-world distribution. The aggregation may facilitate the generation of mappings that represent current labor market trends and conditions with a high degree of precision.

Moreover, the process 200 may dynamically adjust mappings (e.g., based on market trends) as new data becomes available, allowing for real-time updates that account for emerging trends in labor demand. Through a combination of data weighting, time-based adjustments, and proportional analysis, process 200 may determine mappings that detail the current landscape and provide adaptable, up-to-date labor insights. Based on the mappings, the system may provide granular and localized workforce estimates that are valuable for businesses seeking insight into specific skill distributions within broader occupational categories.

At step 240, the process 200 may evaluate the quality and reliability of the generated mappings by calculating confidence intervals for each proportion. The confidence intervals may be calculated using one or more statistical methods such as bootstrapping, resampling the dataset multiple times to simulate potential variances and derive an interval for each mapping. For example, in regions with sparse data, reliability may be estimated based on variance across simulated samples. For areas with abundant data, narrower confidence intervals may be calculated, reflecting the higher certainty in workforce estimates. Moreover, Bayesian inference may be employed when historical data is available, incorporating prior knowledge to adjust estimates and provide realistic confidence intervals for regions or roles with limited data.

The process 200 may dynamically adjust the confidence interval based on various factors associated with the labor market data, such as geographic granularity, occupational specificity, and/or volume of available data sources. Geographic granularity may refer to the level of detail in the regional data, such as whether the labor market information pertains to a city, metropolitan area, or entire country. For example, a narrower confidence interval may be applied to regions with highly localized and detailed data, whereas broader intervals may be used for larger, less granular areas with aggregated data. Occupational specificity may be associated with the precision of the occupation classification, such as broad categories like “engineers” versus more specific roles like “aerospace engineers.” Data with higher specificity may result in wider confidence intervals if the sample size for specialized roles is limited. Moreover, the volume of available data sources, such as government LMI, job postings, and/or worker profiles, may impact the confidence interval. Regions or occupations with multiple corroborative data sources may yield narrower intervals, while regions or occupations relying on a single or sparse dataset may have broader intervals. In some aspects, the labor market data (e.g., including geographic granularity, occupational specificity, and/or data volume) may be sampled across multiple geographic regions to identify patterns and calibrate confidence intervals appropriately, ensuring robust and reliable workforce estimates.

When direct data is insufficient, the process 200 may introduce proxy data from comparable regions, providing continuity in data quality and reliability. The process 200 may assign wider confidence intervals to mappings that rely on proxy data, indicating reduced reliability due to proxy usage. Moreover, weighted averaging techniques may be applied during aggregation, allowing the process 200 to account for region-specific differences in data quality. This evaluation may ensure that mappings are presented with a clear degree of certainty, allowing users to interpret workforce estimates accurately and with consideration of the underlying reliability of the data. Through these steps, process 200 may equip businesses with high-confidence labor market insights that adapt to both granular and aggregated levels, supporting well-informed workforce planning.

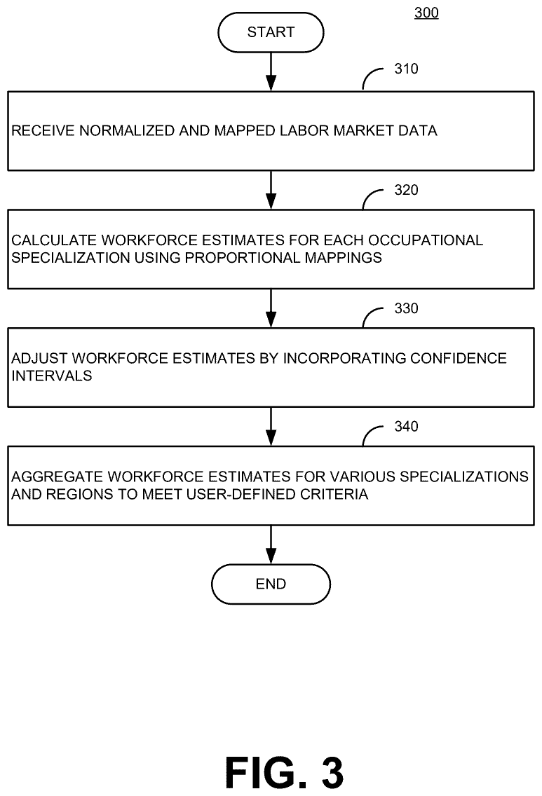

FIG. 3 illustrates an example of a process 300 for calculating workforce estimates. At step 310, the process 300 may receive normalized and mapped labor market data. The normalized and mapped market data may include aggregated labor statistics aligned with a predefined occupational taxonomy, such as the International Standard Classification of Occupations (ISCO-08). Each occupational classification may be associated with specific proportions derived from the mappings, e.g., determined by process 200. For example, if a region reports 5,000 software developers and a mapping indicates that 60% specialize in Java development, the process assigns a proportional value to represent the Java developer workforce. By utilizing these mappings, the process 300 may enable the calculation of specialized occupational sizes with precision, thereby providing compatibility and standardization across various datasets.

At step 320, the process 300 may calculate workforce estimates for each occupational specialization using proportional mappings. The process 300 may apply the determined ratios to the aggregated workforce data to generate estimates for low, mid, and high ranges, reflecting varying levels of certainty. For example, in a region with 10,000 workers categorized as engineers, where mappings indicate 30% are mechanical engineers and 50% are electrical engineers, the process 300 may calculate the number of mechanical engineers as 3,000 and electrical engineers as 5,000. Each estimate may be further refined using statistical techniques to account for data variability and ensure accuracy. By segmenting the workforce into granular categories, actionable insights may be tailored to specialized labor market needs.

At step 330, the process 300 may adjust workforce estimates by incorporating confidence intervals that account for the reliability and variability of the data. The confidence intervals may be determined based on factors such as sample size, data quality, and/or geographic granularity. For example, if the data for a region is sparse, resulting in wider confidence intervals, the process 300 may calculate a broader range for workforce estimates to indicate reduced certainty. Regions with robust data may produce narrower confidence intervals, reflecting higher reliability. This adjustment of confidence intervals may provide businesses with estimates that appropriately represent the degree of uncertainty in the underlying data, enabling informed decision-making in workforce planning.

At step 340, the process 300 may aggregate workforce estimates for various specializations and regions to meet user-defined criteria. The aggregation may include summing mid-range estimates while recalibrating low and high ranges using techniques, such as weighted averaging or Pythagorean summation. For example, when estimating the workforce size for software developers across multiple metropolitan areas, the process 300 may combine individual estimates while maintaining statistically valid confidence intervals. The aggregated output may provide users with comprehensive workforce insights that are scalable and reliable, catering to broader analytical or strategic objectives. The aggregated data may be prepared for transmission via APIs or user interfaces, offering seamless integration with business intelligence tools.

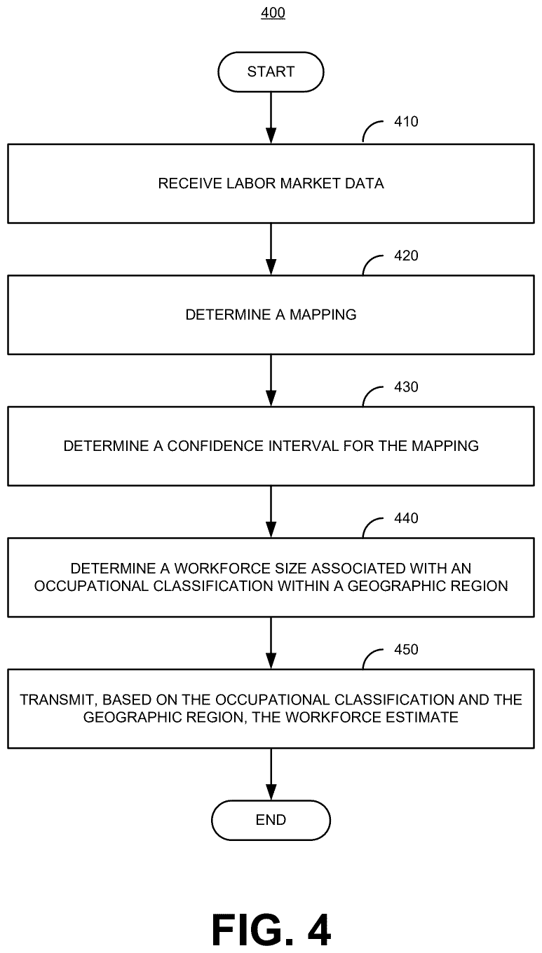

FIG. 4 illustrates an example of a process 400 for modeling labor markets and providing workforce estimates.

At step 410, the process 400 may receive labor market data from a wide array of sources, such as government labor market information (LMI), job postings, worker profiles, and/or private databases. Moreover, the labor market data may include one or more of LMI, job postings, worker profiles, etc. The data ingestion may be facilitated through automated pipelines employing application programming interfaces (APIs) and/or web scraping techniques to ensure comprehensive and real-time data acquisition. The received data may include both structured information, such as LMI or numerical employment statistics, and unstructured data, such as descriptive job postings. The raw data may be preprocessed to validate completeness and consistency before downstream processing. For example, worker profiles from professional networks may be analyzed to extract key fields such as skills, job titles, and location identifiers, ensuring their compatibility with the system's analytical models.

Ane or more advanced validation mechanisms may address the diverse formats and quality of incoming labor market data. The mechanisms may include error-detection algorithms that flag incomplete or inconsistent entries for review. For example, if a job posting omits a location field or contains ambiguous job titles, the anomalies may be logged, and placeholders may be assigned to maintain workflow continuity. Moreover, duplicates may be identified and removed through record-linking techniques to avoid overrepresentation of data points. For example, duplicate job postings for “software engineers” listed by multiple platforms may be merged into a single entry, reducing noise and redundancy.

Furthermore, the process 400 may utilize multilingual processing to accommodate regional variations in labor market data reporting. For example, a job posting written in Spanish for “Desarrollador de Software” may be translated and standardized into its English equivalent, “Software Developer.” The standardize translation may be performed using NLP models fine-tuned on labor market vocabulary, ensuring the semantic integrity of translated data. By harmonizing disparate data sources into a unified input framework, this process 400 may lay the groundwork for accurate mapping, confidence interval determination, and workforce estimation.

At step 420, the process 400 may determine a mapping of the labor market data to an occupation taxonomy. According to some aspects, the process 400 may map the labor market data to a predefined occupation taxonomy, such as the International Standard Classification of Occupations (ISCO-08). Moreover, the process 400 may determine a mapping between multiple occupation taxonomies based on the labor market data. One or more fields may be extracted from the labor market data and the mapping may be created based on the one or more extracted fields. For example, a first taxonomy may categorize occupations at a general level, such as “Engineers,” while a second taxonomy may provide a more detailed breakdown, such as “Software Engineers” and “Mechanical Engineers.” The hierarchical structure of the taxonomies may facilitate the alignment of broader categories to their respective subcategories, ensuring that the labor market data is seamlessly translated into a more granular framework. One or more machine learning models may analyze job titles, descriptions, and associated skill sets to refine the mapping, ensuring that roles are accurately categorized within the broader occupational hierarchy.

Moreover, the process 400 may include proportional analysis to address inconsistencies and variations between taxonomies. For example, if a national taxonomy categorizes 10,000 workers under “Health Professionals,” and an international taxonomy includes subcategories such as “General Practitioners” and “Nurses,” the mapping may distribute these workers proportionally based on skill and role data extracted from government LMI, job postings, and/or profiles. The hierarchical relationships within the taxonomies may be used to determine the proportional distribution and provide consistency in alignment. The process 400 may further include feedback loops to provide iterative adjustments to mappings as new data sources and occupational trends emerge.

In instances where labor market includes one or more gaps or inconsistencies, proxy mappings from comparable regions or roles may be used based on the hierarchical structures of the taxonomies. For example, if data for “Cloud Engineers” is sparse in a specific region, the process 400 may utilize ratios from a similar occupational category, such as “Software Engineers,” within the same taxonomy to approximate the distribution. By dynamically integrating hierarchical relationships and leveraging proxy data, when necessary, the process 400 may ensure that mappings between taxonomies are both accurate and adaptable to changing labor market conditions. Moreover, the determined mappings may enable process 400 to generate workforce estimates with improved granularity and reliability.

Mapping of the labor market data may include associating job titles, skills, and/or other attributes from the raw data with standardized occupational categories, resolving discrepancies across sources and regions. For example, “Full-Stack Developer” from a job posting and “Software Engineer” from a government LMI source may be mapped to the broader ISCO-08 category of “Software Developers.” Machine learning models trained on historical labor data refine these mappings, dynamically adjusting for evolving occupational trends.

Proportional analysis may be used to account for nuanced relationships between general categories and specialized roles. For example, if 10,000 workers in a region are categorized as “Software Developers” in LMI data, and job postings indicate that 60% of these developers specialize in Java, the mapping process may align 6,000 workers to the “Java Developer” subcategory. The proportional mapping may be validated by cross-referencing with external data sources or feedback loops that incorporate user interactions to improve accuracy over time.

Gaps in labor market data may be addressed by leveraging proxy regions with similar socio-economic characteristics. For example, if data for “Data Scientists” in a small city is insufficient, proportional mappings may be borrowed from a comparable metropolitan area with robust data. By standardizing diverse inputs into a cohesive taxonomy, labor market insights may be comparable across regions, enabling informed decision-making by users. Comparable regions may be determined based on metrics such as population size, industry composition, and other socio-economic factors that reflect similar labor market conditions. For example, a small city with a population primarily engaged in technology sectors may be compared to a metropolitan area with a similar technological focus, even if the metropolitan area is larger. Industry similarity metrics may include the proportion of workers employed in specific sectors, such as software development, healthcare, or manufacturing, ensuring that the proxy region accurately reflects the occupational demand and supply characteristics of the region with insufficient data. Additional considerations, such as workforce education levels, economic growth rates, and/or unemployment rates, may also be factored into the determination of comparable regions. By employing these similarity metrics, the mapping process may select the most appropriate proxy region, reducing discrepancies and improving the accuracy of workforce estimates derived from substitute data.

At step 430, the process 400 may determine a confidence interval for the mapping. The reliability of each mapping may be determined by evaluating factors such as data volume, quality, and/or regional granularity. For example, mappings derived from a dataset with numerous job postings and worker profiles will have narrower confidence intervals compared to mappings based on sparse or incomplete data. Bayesian inference techniques may be used to integrate prior knowledge, such as historical labor patterns, with new data, enhancing the robustness of these intervals.

When labor market data is sparse, the process 400 may incorporate proxy data to generate meaningful confidence intervals. For example, if data for “Machine Learning Engineers” in a small town is unavailable, proportional mappings from a similar urban center are used, but the confidence interval is widened to reflect this approximation. Additionally, bootstrapping methods resample the data to simulate variability and derive an empirical distribution, offering a statistical basis for confidence interval calculation.

Confidence intervals may be dynamically adjusted based on the aggregation of data from multiple regions or occupations. For example, when combining workforce estimates for “Data Analysts” across several cities, the confidence interval calculation may consider the heterogeneity of data sources and regional differences. Dynamic adjustment of the confidence intervals may ensure that the final confidence intervals accurately reflect the level of uncertainty, enabling users to assess the reliability of workforce estimates.

At step 440, the process 400 may determine, based on the mapping, the confidence interval, and/or government LMI, a workforce size for an occupational classification within a geographic region. The process 400 may calculate the workforce size for specific occupational classifications within geographic regions using the mappings and confidence intervals determined in previous steps of process 400. Proportional mappings may be applied to labor market data (e.g., government LMI) to derive estimates for granular occupational categories. For example, if Chicago reports 20,000 workers in the “Software Developers” category and 25% are mapped to “Backend Developers,” the process 400 may estimate 5,000 backend developers in Chicago. The calculations may be stratified into low, mid, and high estimates to account for data variability.

According to some aspects, determining the workforce size associated with the occupational classification within the geographic region may include replacing the government LMI with LMI associated with a comparable geographic region, e.g., when a sample size of the labor market data does not meet a minimum threshold of reliability. Proxy data (e.g., government LMI) from comparable regions may be used to enhance workforce size calculations when direct data is unavailable. For example, in estimating the number of “Cybersecurity Specialists” in a rural area, the process 400 may use ratios derived from metropolitan centers with similar industry profiles, such as nearby cities. The calculations may be weighted based on the similarity metrics of proxy regions, such as economic activity and occupational demands, ensuring that estimates are contextually relevant.

The threshold of reliability for labor market data (e.g., government LMI) may be determined using a combination of statistical and/or heuristic techniques to evaluate the robustness and/or representativeness of the data. For example, reliability may be assessed by calculating metrics such as standard error, variance, or a coefficient of variation, which may indicate stability or precision of the dataset. Moreover, heuristic thresholds, such as a minimum number of job postings or worker profiles for a specific occupation within a defined geographic region, may be established based on historical data trends or industry standards. A data quality scoring system may also be applied, where factors such as size, recency, completeness, and/or consistency of the labor market data may be weighted and aggregated into a reliability score. If the determined reliability score falls below a predefined threshold (e.g., minimum threshold of reliability), the data may be flagged as unreliable.

According to some aspects, the minimum threshold of reliability may be defined in terms of numerical benchmarks or probabilistic confidence levels. For example, a region may require at least 100 data points for an occupational classification to meet the minimum sample size requirement. Alternatively, a confidence level, such as achieving a 95% confidence interval with an acceptable margin of error, may be used to set the threshold. Data quality criteria may include contextual considerations, such as whether the data sufficiently captures diversity in job roles or geographic coverage. If the labor market data fails to meet one or more of the predefined benchmarks, the labor market data may be considered insufficient for accurate workforce estimation.

According to some aspects, when a sample size of the labor market data does not meet the minimum threshold of reliability, determining the workforce size associated with the occupational classification within the geographic region may include replacing the unreliable government LMI with data from a comparable geographic region. This replacement may prioritize regions that share similar socio-economic characteristics, population demographics, industry presence, or labor market trends with the target region. Matching algorithms or machine learning models may be used to identify the most appropriate proxy region. For example, if labor market data for a rural region is insufficient, LMI from another rural area with comparable economic activity and industry composition may be substituted. The use of proxy data may be accompanied by adjustments to confidence intervals to reflect the increased uncertainty introduced by the substitution, ensuring transparency and reliability in the resulting workforce size determination.

According to some aspects, the process 400 may integrate real-time labor market (e.g., government LMI) updates to refine workforce estimates dynamically. For example, as new job postings for “Cloud Architects” emerge, the proportional mappings may be adjusted, and workforce size estimates may be recalibrated. This adaptability may enable the process 400 to remain aligned with evolving labor market trends, ensuring that businesses have access to current and accurate workforce data for strategic planning.

According to some aspects, the workforce size estimate may be dynamically updated in response to one or more economic events by recalibrating both the mapping of labor market data to occupation taxonomies and the associated confidence intervals. Economic events that may trigger the updates may include changes in employment regulations (e.g., new minimum wage laws or labor policies), technological advancements (e.g., the emergence of AI-driven roles or green energy jobs), and/or macroeconomic shifts such as economic downturns or surges in regional industry demand. For example, if a new technology hub emerges in a geographic region due to investment in the tech sector, the process 400 may adjust the proportions of occupational classifications to account for an increase in demand for software engineers and data scientists. Similarly, confidence intervals may be updated to reflect the increased volume and quality of labor market data resulting from the rapid expansion of job postings and worker profiles in the region. This dynamic adjustment may ensure that workforce size estimates remain accurate and aligned with real-time labor market trends, providing users with up-to-date insights to support data-driven decision-making.

At step 450, the process 400 may transmit, based on the occupational classification and the geographic region, the workforce estimate. The workforce estimates may be transmitted to user interfaces or external systems via APIs, enabling seamless integration with business intelligence platforms. For example, an HR software platform may query the API to retrieve workforce estimates for “Data Engineers” in Silicon Valley and directly use this data for workforce planning. The transmitted estimates may include low, mid, and high ranges, accompanied by confidence intervals to provide a comprehensive understanding of data reliability.

The process 400 may support customizable outputs tailored to specific user requirements. For example, a user interested in assessing regional trends for “AI Specialists” may receive aggregated estimates visualized through heatmaps or graphs. The outputs may be dynamically adjusted to reflect the granularity of the user's query, such as filtering by skill level or geographic scope. By customizing the outputs, the transmitted insights may be actionable and aligned with the user's strategic needs.

To enhance accessibility, the process 400 may deliver workforce estimates through batch processing for large-scale analyses and real-time queries for ad hoc insights. For example, a multinational corporation may use the system to evaluate workforce availability for “Supply Chain Analysts” across global locations before expanding its operations. By offering versatile data delivery options, this process 400 may ensure that businesses can seamlessly incorporate labor market analytics into their decision-making workflows.

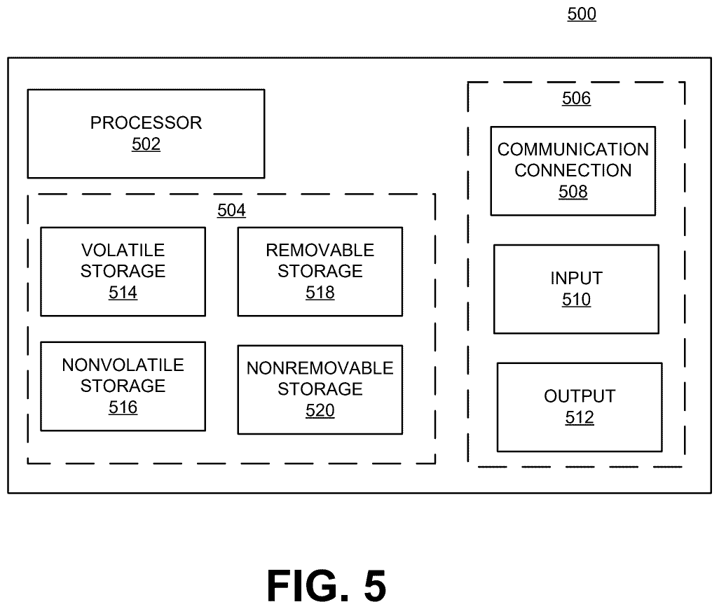

FIG. 5 is a block diagram of a computing device 500 that may be connected to or comprise a component of system 102. Computing device 500 may comprise hardware or a combination of hardware and software. The functionality to model labor markets and provide workforce estimates may reside in one or a combination of computing devices 500. Computing device 500 depicted in FIG. 5 may represent or perform functionality of an appropriate computing device 500, or a combination of computing devices 500, such as, for example, a component or various components of a workforce estimation system, a computing device, a processor, a server, a gateway, a database, a firewall, a router, a switch, a modem, an encryption tool, a virtual private network (VPN), or the like, or any appropriate combination thereof. It is emphasized that the block diagram depicted in FIG. 5 is an example and is not intended to imply a limitation to a specific example or configuration. Thus, computing device 500 may be implemented in a single device or multiple devices (e.g., single server or multiple servers, single gateway or multiple gateways, single controller, or multiple controllers). Multiple network entities may be distributed or centrally located. Multiple network entities may communicate wirelessly, via hard wire, or any appropriate combination thereof.

Embodiments of the computing device 500 may comprise a processor 502 and a memory 504 coupled to processor 502. The memory 504 may contain executable instructions that, when executed by the processor 502, may cause the processor 502 to effectuate operations associated with modeling labor markets and providing workforce estimates. As evident from the description herein, the computing device 500 is not to be construed as software per se.

In addition to a processor 502 and memory 504, a computing device 500 may include an input/output system 506. The processor 502, memory 504, and input/output system 506 may be coupled together (coupling not shown in FIG. 5) to allow communications between them. Each portion of the computing device 500 may comprise circuitry for performing functions associated with each respective portion. Thus, each portion may comprise hardware, or a combination of hardware and software. Accordingly, each portion of a computing device 500 is not to be construed as software per se. An input/output system 506 may be capable of receiving or providing information from or to a communications device or other network entities configured for modeling labor markets and providing workforce estimates. For example, the input/output system 506 may include a wireless communication (e.g., 3G/4G/5G/GPS) card. The input/output system 506 may be capable of receiving or sending video information, audio information, control information, image information, data, or any combination thereof. Input/output system 506 may be capable of transferring information with the computing device 500. In various configurations, the input/output system 506 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, the input/output system 506 may comprise a Wi-Fi finder, a two-way GPS chipset or equivalent, or the like, or a combination thereof.

Embodiments of the input/output system 506 of a computing device 500 also may contain a communication connection 508 that allows the computing device 500 to communicate with other devices, network entities, or the like. The communication connection 508 may comprise communication media. Communication media may typically embody computer-readable instructions, data structures, program modules or other data in a modulated data signal such as a carrier wave or other transport mechanism and may include any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. The input/output system 506 also may include an input device 510 such as keyboard, mouse, pen, voice input device, or touch input device. The input/output system 506 may also include an output device 512, such as a display, speakers, or a printer.

Embodiments of the processor 502 may be capable of performing functions associated with modeling labor markets and providing workforce estimates, as described herein. For example, a processor 502 may be capable of, in conjunction with any other portion of the computing device 500, fine-tuning multilingual machine translation models, as described herein.

Embodiments of a memory 504 of the computing device 500 may comprise a storage medium having a concrete, tangible, physical structure. As is known, a signal does not have a concrete, tangible, physical structure. The memory 504, as well as any computer-readable storage medium described herein, is not to be construed as a signal. The memory 504, as well as any computer-readable storage medium described herein, is not to be construed as a transient signal. The memory 504, as well as any computer-readable storage medium described herein, is not to be construed as a propagating signal. The memory 504, as well as any computer-readable storage medium described herein, is to be construed as an article of manufacture.

The memory 504 may store any information utilized in conjunction with modeling labor markets and providing workforce estimates. Depending upon the exact configuration or type of processor, a memory 504 may include a volatile storage 514 (such as some types of RAM), a nonvolatile storage 516 (such as ROM, flash memory), or a combination thereof. The memory 504 may include additional storage (e.g., a removable storage 518 or a non-removable storage 520) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by a computing device 500. The memory 504 may comprise executable instructions that, when executed by a processor 502, cause the processor 502 to effectuate operations associated with modeling labor markets and providing workforce estimates.

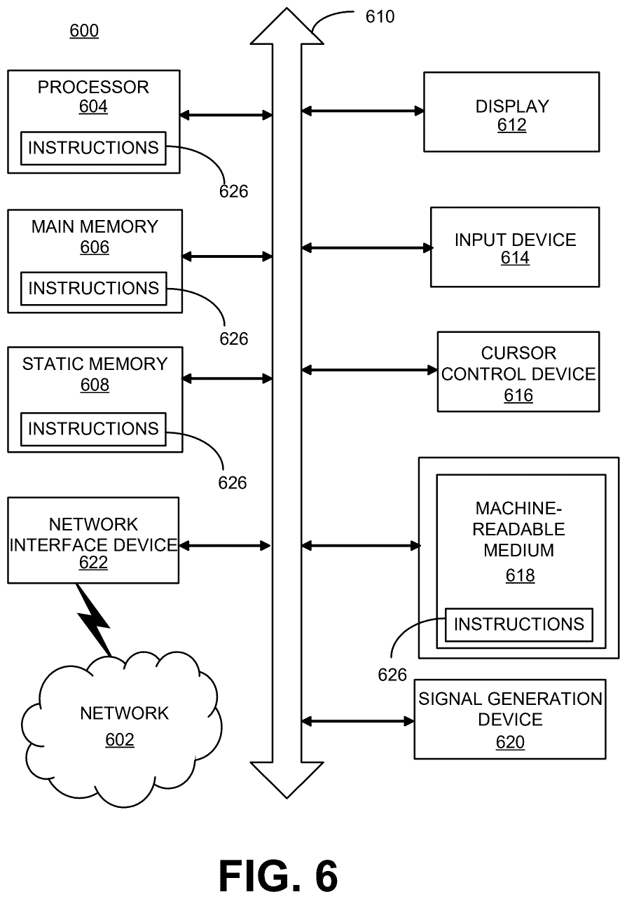

FIG. 6 depicts an example of a diagrammatic representation of a machine in the form of a computer system 600 within which a set of instructions, when executed, may cause the machine to perform any one or more of the methods described above. One or more instances of the machine can operate, for example, as computing device(s) 104, system 102, server 108, database 110, processor 504, and other devices of FIGS. 1-5. In some examples, the machine may be connected (e.g., using a network 602) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video, or data communication. Further, while a single machine is illustrated, the term “machine” shall also be taken to include any collection of machines that individually or jointly execute a set (or multiple sets) of instructions to perform any one or more of the methods discussed herein.

A computer system 600 may include a processor (or controller) 604 (e.g., a central processing unit (CPU)), a graphics processing unit (GPU, or both), a main memory 606 and a static memory 608, which communicate with each other via a bus 610. The computer system 600 may further include a display unit 612 (e.g., a liquid crystal display (LCD), a flat panel, or a solid-state display). The computer system 600 may include an input device 614 (e.g., a keyboard), a cursor control device 616 (e.g., a mouse), a disk drive unit 618, a signal generation device 620 (e.g., a speaker or remote control) and a network interface device 622. In distributed environments, the examples described in the subject disclosure can be adapted to utilize multiple display units 612 controlled by two or more computer systems 600. In this configuration, presentations described by the subject disclosure may in part be shown in a first of display units 612, while the remaining portion is presented in a second of display units 612.

The disk drive unit 618 may include a tangible computer-readable storage medium on which is stored one or more sets of instructions (e.g., instructions 626) embodying any one or more of the methods or functions described herein, including those methods illustrated above. Instructions 626 may also reside, completely or at least partially, within the main memory 606, the static memory 608, or within the processor 604 during execution thereof by the computer system 600. The main memory 606 and the processor 604 also may constitute tangible computer-readable storage media.

While examples of a system for modeling labor markets and providing workforce estimates have been described in connection with various computing devices/processors, the underlying concepts may be applied to any computing device, processor, or system capable of fine-tuning multilingual machine translation models. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer readable storage medium is not a propagating signal. A computer-readable storage medium as described herein is an article of manufacture. When the program code is loaded into and executed by a machine, such as a computer, the machine becomes a device for modeling labor markets and providing workforce estimates. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with modeling labor markets and providing workforce estimates as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an erasable programmable read-only memory (EPROM), a gate array, a programmable logic device (PLD), a client computer, or the like, the machine becomes a device for modeling labor markets and providing workforce estimates as described herein. When implemented on a general-purpose processor, the program code combines with the processor to provide a unique device that operates to invoke the functionality of a workforce estimation system.

While the disclosed systems have been described in connection with the various examples of the various figures, it is to be understood that other similar implementations may be used, or modifications and additions may be made to the described examples of a workforce estimation system without deviating therefrom. For example, one skilled in the art will recognize that a workforce estimation system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—modeling labor markets and providing workforce estimates—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

What is claimed:

1. One or more computing devices, comprising one or more processors, configured to:
receive labor market data;
determine, based on the labor market data, a mapping between a plurality of occupation taxonomies;
determine a confidence interval for the mapping;
determine a workforce size associated with an occupational classification within a geographic region based on the mapping, the confidence interval, and government labor market information (LMI); and
transmit, based on the occupational classification and the geographic region, the workforce estimate.

2. The one or more computing devices of claim 1, further configured to extract one or more fields from the labor market data, wherein the mapping is determined based on the one or more fields.

3. The one or more computing devices of claim 1, further configured to adjust the mapping based on one or more market trends.

4. The one or more computing devices of claim 1, wherein determining the workforce size associated with the occupational classification within the geographic region comprises replacing the government LMI with LMI associated with a comparable geographic region when a sample size of the labor market data does not meet a minimum threshold of reliability.

5. The computing devices of claim 1, further configured to aggregate a plurality of workforce estimates across a plurality of occupational classifications and a plurality of regions.

6. The one or more computing devices of claim 1, wherein the labor market data comprises employment statistics associated with an occupation taxonomy of the plurality of occupation taxonomies and the geographic region.

7. The one or more computing devices of claim 1, wherein the labor market data comprises a sample of labor market data for each occupation in a region, wherein determining the confidence interval for the mapping is based on the sample of labor market data.

8. The one or more computing devices of claim 1, further configured to replace the mapping with another mapping associated with a comparable geographic region when a sample size of the labor market data does not meet a minimum threshold of reliability.

9. The one or more computing devices of claim 8, wherein the comparable region is determined based on the workforce size associated with the geographic region and occupation groups associated with the geographic region.

10. The one or more computing devices of claim 1, wherein the workforce size comprises a low estimate, a mid-estimate, and a high estimate.

11. The one or more computing devices of claim 1, wherein the workforce estimate is transmitted via an application programming interface (API).

12. The one or more computing devices of claim 1, wherein the transmission of the workforce estimate is based on user-specified criteria.

13. The one or more computing devices of claim 1, further configured to adjust the confidence interval based on one or more of a geographic granularity associated with the labor market data, an occupational specificity associated with the labor market data, or a volume of available data sources associated with the labor market data.

14. The one or more computing devices of claim 13, wherein the confidence interval is determined based on sampling labor market data across geographic regions.

15. The one or more computing devices of claim 1, wherein the labor market data comprises proxy data from one or more comparable geographic regions to the geographic region.

16. The one or more computing devices of claim 15, wherein the one or more comparable geographic regions are determined based on socio-economic, population, or industry similarity metrics.

17. The one or more computing devices of claim 1, further configured to dynamically update, in response to one or more economic events, the workforce size by updating the mapping and by updating the confidence interval.

18. The one or more computing devices of claim 1, wherein the mapping comprises one or more proportional mappings between the ISCO-08 occupations, geographic regions, and the occupation taxonomy.

19. A method performed by one or more computing devices, the method comprising:
receiving labor market data;
determining, based on the labor market data, a mapping between a plurality of occupation taxonomies;
determining a confidence interval for the mapping;
determining a workforce size associated with an occupational classification within a geographic region based on the mapping, the confidence interval, and government labor market information (LMI); and
transmitting, based on the occupational classification and the geographic region, the workforce estimate.

20. A system comprising:
one or more processors; and
a memory coupled with the one or more processors, the memory storing executable instructions that when executed by the one or more processors cause the one or more processors to effectuate operations comprising:
receiving labor market data;
determining, based on the labor market data, a mapping between a plurality of occupation taxonomies;
determining a confidence interval for the mapping;
determining a workforce size associated with an occupational classification within a geographic region based on the mapping, the confidence interval, and government labor market information (LMI); and
transmitting, based on the occupational classification and the geographic region, the workforce estimate.
